(19) United States
(12) Patent Application Publication
(10) Pub. No.: US 2025/0239959 A1
(43) Pub. Date: Jul. 24, 2025

(54) ELECTRIC POWER CONVERSION DEVICE

(71) Applicants: TOYOTA JIDOSHA KABUSHIKI KAISHA, Toyota-shi (JP); DENSO CORPORATION, Kariya-city (JP)

(72) Inventors: Takashi YANAGI, Toyota-shi (JP); Takuya ISOMURA, Aichi-gun (JP); Yoshiko YAMADA, Toyota-shi (JP); Yuta TOTSUKA, Anjo-shi (JP); Yoshiki KATO, Kariya-city (JP); Yuki KUBO, Kariya-city (JP)

(73) Assignees: TOYOTA JIDOSHA KABUSHIKI KAISHA, Toyota-shi (JP); DENSO CORPORATION, Kariya-city (JP)

(21) Appl. No.: 18/987,991

(22) Filed: Dec. 19, 2024

(30) Foreign Application Priority Data
Jan. 18, 2024 (JP) 2024-006182

(51) Int. Cl. H02P 29/68

(52) U.S. Cl. CPC H02P 29/68

(57) ABSTRACT

An electric power conversion device wherein: a state determination unit determines that a motor is in a locked state when the number of revolutions of the motor is equal to or smaller than a first threshold value, and determines that the motor is in a low-speed rotating state that is included in a rotating state when the number of revolutions exceeds the first threshold value and is equal to or smaller than a second threshold value larger than the first threshold value; and an element temperature estimation unit that estimates an element temperature of a switching element provided between a power source and the motor based on a value of a current flowing through the switching element performs the estimation only in the low-speed rotating state included in the rotating state.

### CROSS-REFERENCE TO RELATED APPLICATION

This application claims priority to Japanese Patent Application No. 2024-006182 filed on Jan. 18, 2024, incorporated herein by reference in its entirety.

### BACKGROUND

### 1. Technical Field

The technology disclosed in this Description relates to an electric power conversion device that adjusts an electric power supply from a power source to a motor.

### 2. Description of Related Art

Japanese Unexamined Patent Application Publication No. 2022-183064 (JP 2022-183064 A) discloses a motor-driving inverter device including an inverter circuit that has a plurality of switching elements and a control circuit that controls the inverter circuit. According to JP 2022-183064 A, when the rotation speed of the motor is equal to or lower than a preset rotation speed threshold value and, moreover, the torque of the motor is equal to or higher than a preset torque threshold value, the control circuit changes a temperature estimation logic for the switching elements from a normal estimation logic to a locked-state estimation logic.

### SUMMARY

There has been a problem that continuing element temperature estimation of a switching element at a predetermined sampling frequency in a rotating state of a motor places a significant processing burden on a processor. When the number of revolutions of the motor decreases rapidly due to an external force and the motor transitions to the locked state, the actual temperature of the switching element rises rapidly. Another problem is that when the element temperature estimation is started after the transition to the locked state, a delay in the temperature estimation occurs, which leads to a wider discrepancy between the actual temperature and the estimated temperature. This Description provides a technology that contributes to solving these problems.

This Description discloses an electric power conversion device that adjusts an electric power supply from a power source to a motor. The electric power conversion device includes: a switching element provided between the power source and the motor; a state determination unit that determines whether the motor is in a rotating state or a locked state based on the number of revolutions of the motor; and an element temperature estimation unit that estimates an element temperature of the switching element based on a value of a current flowing through the switching element. The state determination unit determines that the motor is in the locked state when the number of revolutions is equal to or smaller than a predetermined first threshold value, and determines that the motor is in a low-speed rotating state that is included in the rotating state when the number of revolutions exceeds the first threshold value and is equal to or smaller than a predetermined second threshold value that is larger than the first threshold value. The element temperature estimation unit performs the estimation only in the low-speed rotating state included in the rotating state, and when the motor has transitioned from the low-speed rotating state to the locked state, sets the element temperature obtained by the estimation executed in the low-speed rotating state as an initial value of the element temperature in the locked state.

According to this configuration, the element temperature estimation unit performs the estimation only in the low-speed rotating state included in the rotating state. This can reduce the processing burden on the processor in the rotating state. When the low-speed rotating state has transitioned to the locked state, the element temperature estimation unit sets the element temperature obtained by the estimation executed in the low-speed rotating state as the initial value of the element temperature in the locked state. Thus, the element temperature can be obtained without delay in response to a rapid temperature rise in the locked state to thereby reduce the discrepancy between the actual temperature and the estimated temperature.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a view showing the configuration of an electric power conversion device in a simplified form;

FIG. 2 is a view showing a control circuit that executes element temperature estimation in a low-speed rotating state of a motor;

FIG. 3 is a view showing the control circuit that executes the element temperature estimation in a locked state of the motor; and

FIG. 4 is a graph showing an example of transition of an estimated value of an element temperature.

### DETAILED DESCRIPTION OF EMBODIMENTS

An embodiment will be described with reference to the drawings. The drawings merely show examples and the embodiment is not limited to the contents shown in the drawings. Since the drawings are to show examples, the shapes shown are not necessarily accurate or may be partially omitted.

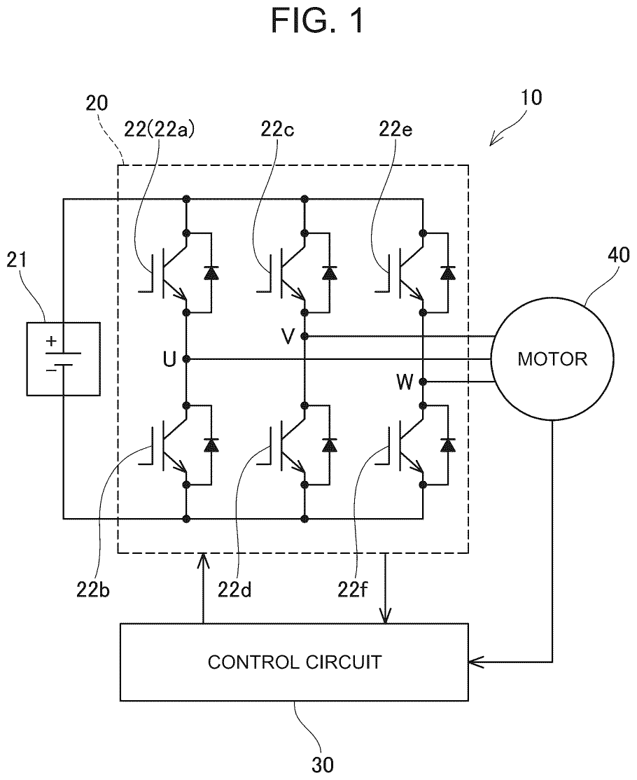

FIG. 1 shows the configuration of an electric power conversion device 10 of the embodiment in a simplified form. The electric power conversion device 10 broadly has an inverter circuit 20 and a control circuit 30 that controls the inverter circuit 20. The electric power conversion device 10 can adjust electric power supplied from a power source 21 to a motor 40. The power source 21 is a direct-current power source, and the inverter circuit 20 converts a direct current supplied from the power source 21 into an alternating current and supplies this alternating current to the motor 40. The electric power conversion device 10 can be adopted for, for example, a battery electric vehicle running on the motor 40, a hybrid electric vehicle, and a fuel cell electric vehicle.

The basic configuration of the inverter circuit 20 will be briefly described. According to the example of FIG. 1, the inverter circuit 20 includes a plurality of switching elements 22a, 22b, 22c, 22d, 22e, 22f provided between the power source 21 and the motor 40, and constitutes a so-called three-phase (a U-phase, a V-phase, and a W-phase) inverter circuit. Hereinafter, each of the switching elements 22a to 22f will also be referred to simply as a switching element 22 without distinction. The circuit configuration of the electric power conversion device 10 is not particularly limited. At a minimum, the electric power conversion device 10 should have at least one switching element 22 for controlling the electric power supply to the motor 40.

Of the switching elements 22a to 22f, the first switching element 22a and the second switching element 22b are connected in series to each other to constitute one leg (e.g., a pair of upper and lower arms) of the three-phase inverter circuit. The first switching element 22a is disposed in the upper arm and the second switching element 22b is disposed in the lower arm. Similarly, of the switching elements 22a to 22f, the third switching element 22c and the fourth switching element 22d are connected in series to each other to constitute another leg of the three-phase inverter circuit. The third switching element 22c is disposed in the upper arm and the fourth switching element 22d is disposed in the lower arm.

Similarly, of the switching elements 22a to 22f, the fifth switching element 22e and the sixth switching element 22f are connected in series to each other to constitute the other leg of the three-phase inverter circuit. The fifth switching element 22e is disposed in the upper arm and the sixth switching element 22f is disposed in the lower arm. While not particularly limited, the switching elements 22 may be, for example, metal-oxide-semiconductor field-effect transistors (MOSFETs) or insulated gate bipolar transistors (IGBTs). A freewheeling diode may be connected in inverse-parallel to each of the switching elements 22.

A connection point of the switching elements 22 in the upper and lower arms of each phase is connected to a coil of the corresponding phase of the motor 40. In the electric power conversion device 10, these switching elements 22a to 22f are selectively and intermittently turned on and off under control by the control circuit 30 to supply three-phase alternating electric power to the motor 40. The control circuit 30 has a plurality of driving ICs and a processor for driving each of the switching elements 22a to 22f. The control circuit 30 may be regarded as one of electronic control units (ECUs).

The control circuit 30 receives a feedback of a signal indicating the number of revolutions of the motor 40 from the motor 40. As the number of revolutions is the number of revolutions per unit time, it may be otherwise called a rotation speed. In addition, the control circuit 30 receives a command relating to a target torque of the motor 40 from a superordinate controller (not shown) and outputs driving signals individually to the switching elements 22a to 22f based on the command and the number of revolutions that has been fed back. While not particularly limited, the driving signals are, for example, pulse-width modulation (PWM) signals.

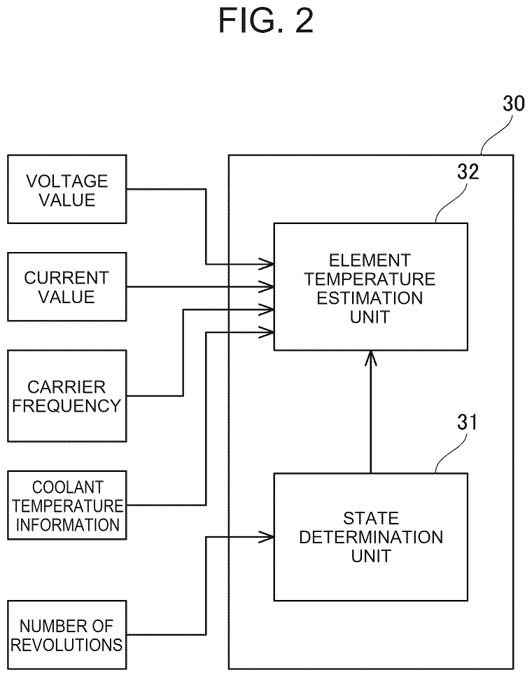

FIG. 2 shows the control circuit 30 that executes element temperature estimation of the switching element 22 in a rotating state of the motor 40. The control circuit 30 includes a state determination unit 31 that determines whether the motor 40 is in the rotating state or a locked state based on the number of revolutions of the motor 40, and an element temperature estimation unit 32 that estimates an element temperature of the switching element 22 based on a value of a current flowing through the switching element 22. The element temperature estimation unit 32 can estimate the element temperature of each of the switching elements 22a to 22f. Of course, the state determination unit 31 and the element temperature estimation unit 32 are merely parts of the function of the control circuit 30.

The element temperature estimation unit 32 receives, from the inverter circuit 20, an input of the values of the currents flowing through the individual switching elements 22 through a circuit for current detection (not shown). In addition, the element temperature estimation unit 32 receives an input of parameters such as a direct-current voltage value of the power source 21, a carrier frequency, and coolant temperature information. The carrier frequency is a frequency for determining a switching frequency of the switching element 22, and is determined by, for example, a functional unit (not shown) that belongs to the control circuit 30 and is responsible for PWM control. The coolant temperature information is information showing the coolant temperature of coolant for cooling the switching element 22. A cooler (not shown) is installed adjacent to a module of the inverter circuit 20, and the coolant temperature of the coolant flowing through an inside of the cooler is input as the coolant temperature information into the element temperature estimation unit 32.

When the number of revolutions of the motor 40 is equal to or smaller than a predetermined first threshold value, the state determination unit 31 determines that the motor 40 is in the locked state. When the number of revolutions of the motor 40 exceeds the first threshold value and is equal to or smaller than a predetermined second threshold value that is larger than the first threshold value, the state determination unit 31 determines that the motor 40 is in a low-speed rotating state included in the rotating state.

The element temperature estimation unit 32 recognizes the state of the motor 40 with reference to the determination by the state determination unit 31. The element temperature estimation unit 32 performs estimation of the element temperature only in the low-speed rotating state included in the rotating state of the motor 40. When estimating the element temperature in the low-speed rotating state of the motor 40, the element temperature estimation unit 32 acquires an effective value of the current flowing through the switching element 22 on a predetermined sampling cycle and uses this effective value for the estimation.

For the estimation of the element temperature based on the current value, various techniques and logics including those that have been hitherto proposed can be adopted. The element temperature estimation unit 32 acquires the element temperature as an estimation result by, for example, inputting the current value into a function, a table, or the like that has been generated beforehand through an experiment or a simulation and optimized for the calculation of the element temperature according to the input.

The element temperature estimation unit 32 may estimate the element temperature based on, in addition to the current value, at least one of the voltage value, the carrier frequency, and the coolant temperature information that are input as described above. Each of the current value, the voltage value, the carrier frequency, and the coolant temperature information can be called a parameter correlated to heat generation of the switching element 22. The element temperature estimation unit 32 may acquire the element temperature as an estimation result by, for example, inputting these parameters into the aforementioned function.

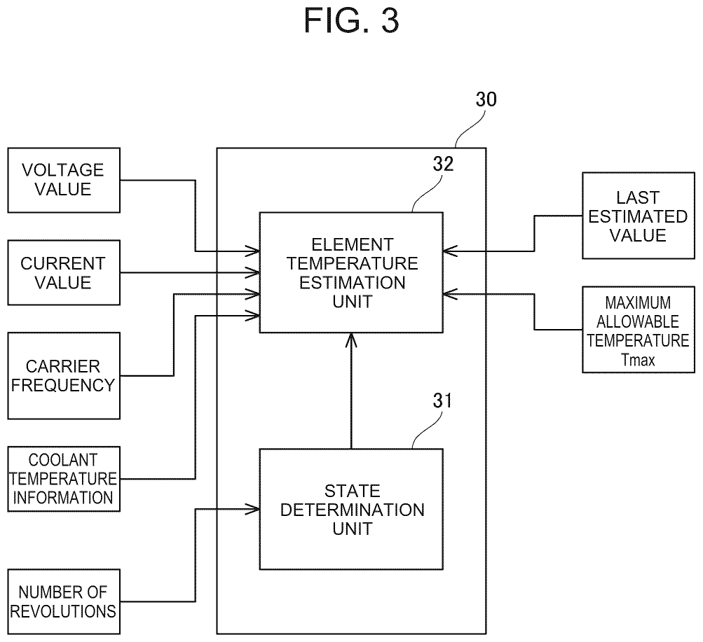

FIG. 3 shows the control circuit 30 that executes the element temperature estimation of the switching element 22 in the locked state of the motor 40. For FIG. 3, the same description as for FIG. 2 will be omitted. When estimating the element temperature in the locked state of the motor 40, the element temperature estimation unit 32 acquires an instantaneous value of the current flowing through the switching element 22 on a predetermined sampling cycle and uses this instantaneous value for the estimation. When the motor 40 has transitioned from the low-speed rotating state to the locked state, the element temperature estimation unit 32 sets the element temperature obtained by the estimation executed in the low-speed rotating state, i.e., the element temperature that has been estimated immediately before the transition to the locked state (last estimated value) as an initial value of the element temperature in the locked state. This means that the element temperature estimation unit 32 has already obtained the estimated value of the element temperature at the moment when the motor 40 falls into the locked state.

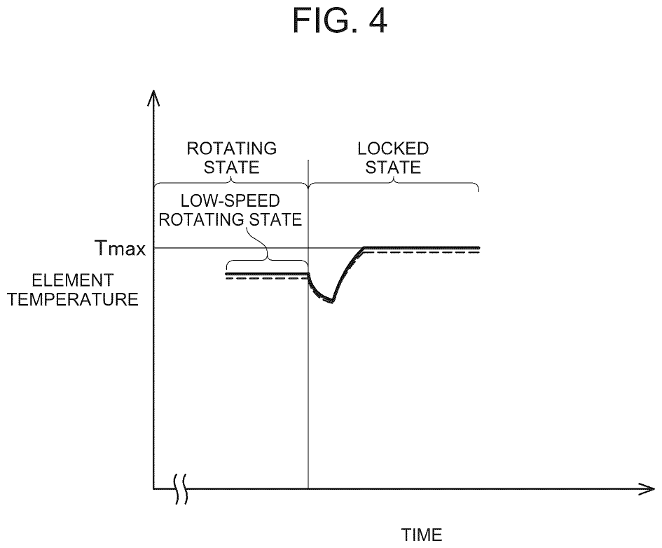

FIG. 4 shows an example of transition of the estimated value of the element temperature according to the embodiment by a graph. In FIG. 4, the estimated value of the element temperature obtained by the element temperature estimation unit 32 is indicated by the solid line, and the actual temperature of the element is indicated by the broken line. According to FIG. 4, when the motor 40 has entered the locked state from the rotating state, the element temperature of the switching element 22 decreases temporarily and then rises rapidly. When the element temperature estimation unit 32 determines that the estimated value of the element temperature has reached a maximum allowable temperature Tmax of the switching element 22, the control circuit 30 reduces an output from the inverter circuit 20 to the motor 40 to thereby protect the switching element 22 from overheating. In this case, the control circuit 30 can reduce electric power consumption of the switching element 22 in various forms including reducing the carrier frequency, reducing the current flowing through the switching element 22, and reducing a duty ratio of the PWM signal. The maximum allowable temperature Tmax is one type of threshold value that the control circuit 30 recognizes in advance. While this is not shown in FIG. 2, the control circuit 30 executes the comparison between the estimated value of the element temperature and the maximum allowable temperature Tmax not only in the locked state but also in the low-speed rotating state.

As has been described, according to the embodiment, the electric power conversion device 10 that adjusts the electric power supply from the power source 21 to the motor 40 includes: the switching elements 22 provided between the power source 21 and the motor 40; the state determination unit 31 that determines whether the motor 40 is in the rotating state or the locked state based on the number of revolutions of the motor 40; and the element temperature estimation unit 32 that estimates the element temperature of each switching element 22 based on the value of the current flowing through the switching element 22. The state determination unit 31 determines that the motor 40 is in the locked state when the number of revolutions is equal to or smaller than the predetermined first threshold value, and determines that the motor 40 is in the low-speed rotating state that is included in the rotating state when the number of revolutions exceeds the first threshold value and is equal to or smaller than the predetermined second threshold value that is larger than the first threshold value. The element temperature estimation unit 32 performs the estimation only in the low-speed rotating state included in the rotating state, and when the motor 40 has transitioned from the low-speed rotating state to the locked state, sets the element temperature obtained by the estimation executed in the low-speed rotating state as the initial value of the element temperature in the locked state.

According to this configuration, the element temperature estimation unit 32 performs the estimation of the element temperature only in the low-speed rotating state included in the rotating state. This can reduce the processing burden on the processor belonging to the control circuit 30 in the rotating state. When the low-speed rotating state has transitioned to the locked state, the element temperature estimation unit 32 sets the last estimated value estimated in the low-speed rotating state as the initial value of the element temperature in the locked state. Thus, the element temperature can be obtained without delay in response to a rapid temperature rise in the locked state, which can reduce the discrepancy between the actual temperature and the estimated temperature. In the case where the element temperature estimation unit 32 estimates, in the locked state, the next latest element temperature based on a parameter such as the current value using, for example, the element temperature that has been once estimated as a basis, since the last estimated value, i.e., the element temperature serving as the basis has been obtained at the point of transition to the locked state, the element temperature can be estimated with high accuracy without delay.

According to the embodiment, the element temperature estimation unit 32 may perform the estimation in the low-speed rotating state based on the effective value of the current. According to this configuration, in the low-speed rotating state of the motor 40, the element temperature estimation unit 32 acquires the effective value of the current flowing through the switching element 22 on the predetermined sampling cycle and uses this effective value for the estimation, which can increase the accuracy of the element temperature estimation.

According to this embodiment, the element temperature estimation unit 32 may perform the estimation in the locked state based on the instantaneous value of the current. According to this configuration, in the locked state of the motor 40, the element temperature estimation unit 32 acquires the instantaneous value of the current flowing through the switching element 22 on the predetermined sampling cycle and uses this instantaneous value for the estimation, which can increase the accuracy of the element temperature estimation in response to a rapid current change.

According to the embodiment, the element temperature estimation unit 32 may perform the estimation based on, in addition to the current value, at least one of the voltage applied to the switching element 22, the carrier frequency that determines the switching frequency of the switching element 22, and the coolant temperature of the coolant for cooling the switching element 22. According to this configuration, the accuracy of the element temperature estimation can be increased by the estimation using various parameters including the current value.

What is claimed is:

1. An electric power conversion device that adjusts an electric power supply from a power source to a motor, comprising:
a switching element provided between the power source and the motor;
a state determination unit that determines whether the motor is in a rotating state or a locked state based on the number of revolutions of the motor; and
an element temperature estimation unit that estimates an element temperature of the switching element based on a value of a current flowing through the switching element, wherein:
the state determination unit determines that the motor is in the locked state when the number of revolutions is equal to or smaller than a predetermined first threshold value, and determines that the motor is in a low-speed rotating state that is included in the rotating state when the number of revolutions exceeds the first threshold value and is equal to or smaller than a predetermined second threshold value that is larger than the first threshold value; and
the element temperature estimation unit performs the estimation only in the low-speed rotating state included in the rotating state, and when the motor has transitioned from the low-speed rotating state to the locked state, sets the element temperature obtained by the estimation executed in the low-speed rotating state as an initial value of the element temperature in the locked state.

2. The electric power conversion device according to claim 1, wherein the element temperature estimation unit performs the estimation in the low-speed rotating state based on an effective value of the current.

3. The electric power conversion device according to claim 1, wherein the element temperature estimation unit performs the estimation in the locked state based on an instantaneous value of the current.

4. The electric power conversion device according to claim 1, wherein the element temperature estimation unit performs the estimation based on, in addition to the current value, at least one of a voltage applied to the switching element, a carrier frequency that determines a switching frequency of the switching element, and a coolant temperature of coolant for cooling the switching element.
